(19) United States
(12) Patent Application Publication
(10) Pub. No.: US 2025/0288485 A1
(43) Pub. Date: Sep. 18, 2025

(54) MASSAGER WITH EXTERNAL MASSAGE ASSEMBLY

(71) Applicant: Yanting CHEN, Guangzhou (CN)

(72) Inventor: Yanting CHEN, Guangzhou (CN)

(21) Appl. No.: 19/224,696

(22) Filed: May 30, 2025

(51) Int. Cl. A61H 19/00

(52) U.S. Cl. CPC A61H 19/32; A61H 2201/1638; A61H 2201/1695

(57) ABSTRACT

A massager with an external massage assembly is provided. The massager includes a handpiece, a massage bracket disposed externally the handpiece, and a driving motor provided in the handpiece. The driving motor is connected to the massage bracket in a transmission manner. A massage body for massaging a penis is provided in the massage bracket. The tightness of the massage bracket is adjusted to strengthen or weaken the constraint on the massage body.

### TECHNICAL FIELD

The present disclosure relates to the technical field of massaging apparatus, and in particular to a massager with an external massage assembly.

### BACKGROUND

With the progress of society, people's living standards are constantly improving, and sub-health conditions are becoming more and more common.

Sub-health in males is particularly evident in the reproductive system. In addition to medical treatment, it can also be combined with special massage instruments for physical therapy and health care. The massaging body of the existing male massage instrument is usually arranged in the main housing, which is not only inconvenient to clean, but also fails to achieve massage effects with varying wrapping feelings. Therefore, a massager with an external massage assembly is provided to solve the problems existing in the prior art.

### SUMMARY

The objective of the present disclosure is to overcome the deficiencies in existing technology by providing a massager with an external massage assembly. A massage body is provided in an adjustable bracket. By adjusting the tightness of the bracket, the constraining on the massage body may be increased or decreased, enabling adaptive adjustment of massage tightness during use. Additionally, different massage bodies may be replaced as needed to meet various usage requirements. The adjustable bracket is mounted on a handle shell, which may conveniently control the movement of the massager, and different massage and health care effects are achieved.

In order to achieve the above object, the present disclosure provides a massager with an external massage assembly, including: a handpiece, a massage bracket arranged externally to the handpiece, and a driving motor provided in the handpiece. The driving motor is connected to the massage bracket in a transmitting manner, and a massage body is provided in the massage bracket for massaging a penis.

In some embodiments, the massage bracket includes a bracket upper cover and a bracket base for constraining the massage body in a radial direction. Adjusting knobs are provided between the bracket upper cover and bracket base for adjusting tightness in the radial direction, the adjusting knobs are configured to adjust a relative distance between the bracket upper cover and bracket base by rotation, so as to adjust the tightness of the massage body in the radial direction.

In some embodiments, connection parts are respectively provided on two sides of the bracket upper cover and extend downwardly for connecting to the bracket base. A groove is formed in each of the connection parts for mating with a corresponding one of the adjusting knobs; when the corresponding one of adjusting knobs is loosened, the corresponding one of the adjusting knobs is configured to move within the groove, so as to adjust the relative distance between the bracket upper cover and bracket base in the radial direction.

In some embodiments, fixing plates with slot structures are respectively provided on two sides of the bracket base for constraining the connection parts. The center of each fixing plate is provided with a fixing screw hole mating with the adjustment knob, facilitating the rotation of the adjusting knobs to adjust the tightness.

In some embodiments, a bottom of the bracket base is provided with at least one hollow connecting column for connecting to the handpiece. The hollow connecting column is provided with internal threads for connection.

In some embodiments, the handpiece is provided with an integrated handle for facilitating gripping. The handpiece is provided with function keys for operating the massage function. A moving groove is formed in the bottom of the handpiece for movement of the massage bracket.

In some embodiments, a movable connecting member is provided in the handpiece and connected to the massage bracket, and the driving motor is connected to the movable connecting member in the transmitting manner so as to drive the massage bracket to move reciprocally on the handpiece along the moving groove.

In some embodiments, the massage body is provided with a hollow massage portion for accommodating the penis.

The working principle of the present disclosure is as follows. According to the massage demand, the massage body with corresponding size is selected and placed in the massage bracket, and the tightness of the massage bracket is adjusted by rotating the adjusting knobs to ensure that the massage body is firmly clamped. When the massage is started, the driving motor is started by pressing the function key, and rotating speed of the motor is controlled. The working state of the driving motor can be automatically switched to forward rotation and reverse rotation. Therefore, when the drive screw rotates, the movable connecting member will be driven to move along the moving groove. The reciprocating speed of the movable connecting member is different with different rotating speeds, so that the massage body may move at different speeds to massage. The user can well control the massage angle by grasping the handle with both hands. The handpiece is provided with multiple function keys, which can control the device, and the control mode is more convenient, thus conforming to the operating habits of different users.

In the actual use process, when the massage bracket clamps the massage body too tightly, the covering massage intensity is relatively high. The user may loosen the adjusting knobs, pull up the bracket upper cover, and then tighten the adjusting knobs again. On the contrary, when the user feel that the clamping intensity is insufficient and the covering intensity of the massage body is weak, resulting in poor massage effect, the user may adjust the bracket upper cover downward and then fix it. Therefore, when using the same massage body, the covering massage intensity of the massage body can be improved through the constraint effect of the massage bracket. Since the massage protrusions inside each massage body are different, the massage body can be conveniently replaced as required.

### BRIEF DESCRIPTION OF THE DRAWINGS

In order to explain the embodiments of the present disclosure or the technical solution in the prior art more clearly, the drawings needed in the embodiments will be briefly introduced below. Apparently, the drawings in the following description are only some embodiments of the present disclosure. For one of ordinary skill in the art, other drawings may be obtained according to these drawings without creative effort.

FIG. 1 is a schematic structural diagram of embodiment 1 of the present disclosure.

FIG. 2 is another perspective view of FIG. 1.

FIG. 3 is a schematic view of the internal structure of FIG. 1 with an upper shell removed.

FIG. 4 is a schematic structural diagram of a massage bracket of the present disclosure.

FIG. 5 is an exploded view of FIG. 4;

FIG. 6 is a schematic structural diagram of a movable connecting member of the present disclosure.

FIG. 7 is a schematic diagram illustrating a mating state of a driving motor and the massage bracket in the present disclosure;

FIG. 8 is a structural schematic diagram of embodiment 2 of the present disclosure.

FIG. 9 is an exploded view of a rack-type massage bracket shown in FIG. 8.

FIG. 10 is a schematic structural diagram of embodiment 3 of the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more obvious and easier to understand, the present disclosure will be further described in detail with the attached drawings and specific embodiments.

### Embodiment 1

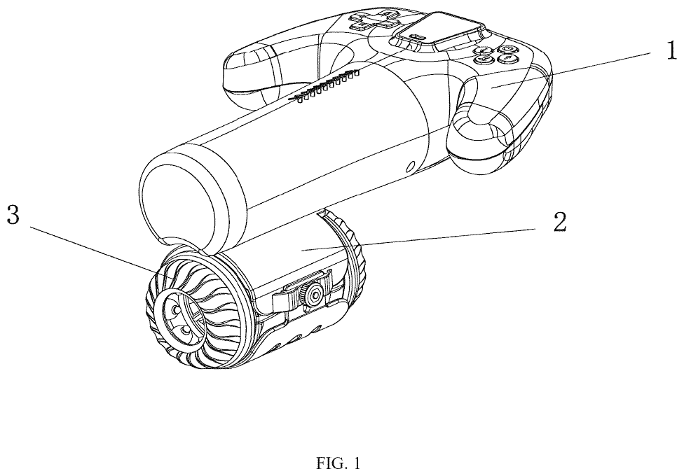

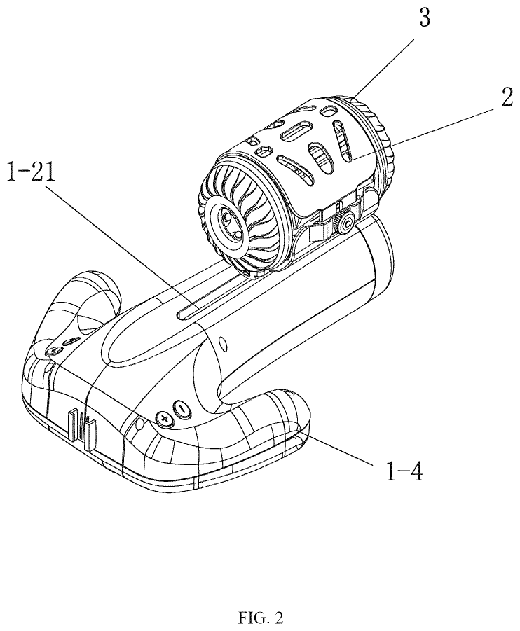

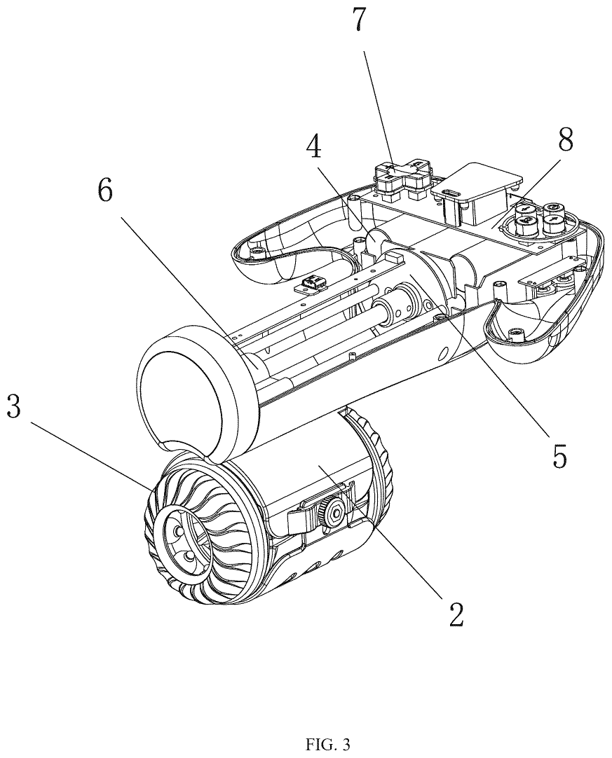

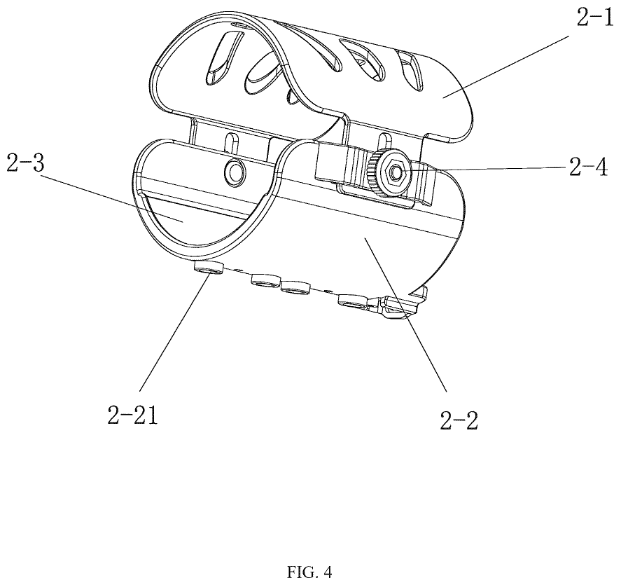

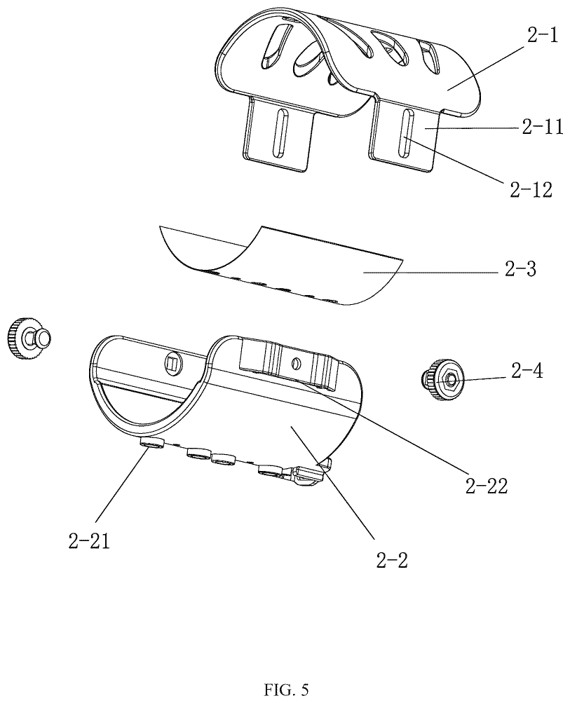

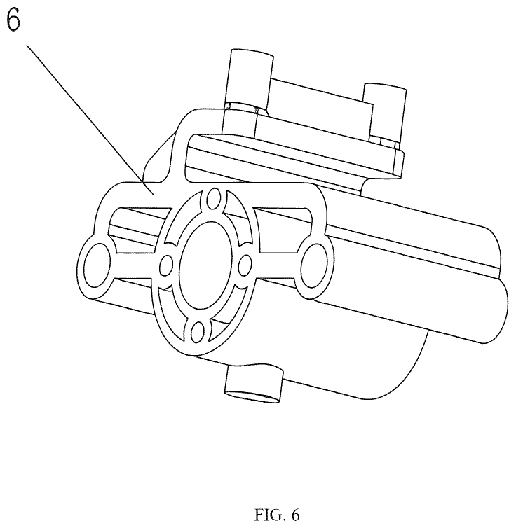

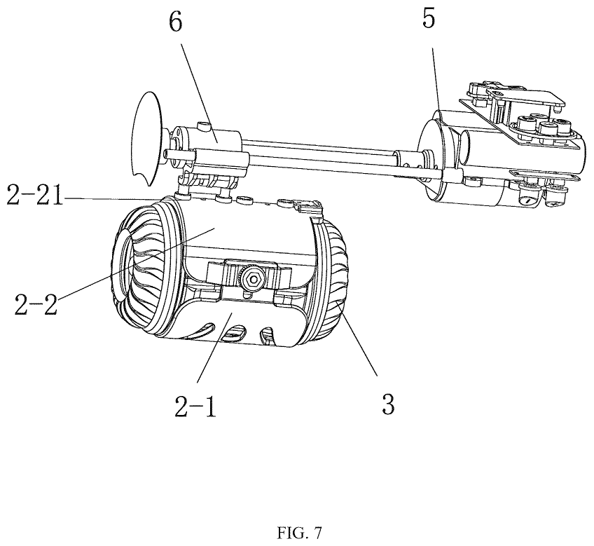

With reference to the FIGS. 1-7, the present disclosure provides a massager with an external massage assembly, including: a handpiece 1, a massage bracket 2 arranged externally to the handpiece 1, and a driving motor 5 provided in the handpiece 1 and connected to the massage bracket 2 in a transmitting manner. The massage bracket 2 is provided with a massage body 3 for massaging a penis. The massage bracket 2 includes a bracket upper cover 2-1 and a bracket base 2-2 that constrain the massage body 3 in the radial direction. Adjusting knobs 2-4 are provided between the bracket upper cover 2-1 and bracket base 2-2 for adjusting tightness in the radial direction. The adjusting knobs 2-4 are configured to adjust the relative distance between the bracket upper cover 2-1 and bracket base 2-2 by rotation, thereby adjusting the tightness of the massage body 3 in the radial direction.

In this embodiment, a handheld structure for an integrated massage device is provided. During use, the user grips the handpiece and performs massage operations via the massage body. Due to the adoption of the external bracket, the massage body is removably mounted within the massage bracket. Moreover, as the massage body 3 is equipped with a hollow massage portion for accommodating the penis, and the inner wall of the massage portion is provided with several massage protrusions, each massage body comes in fixed dimensions. According to the different needs of the user, different massage bodies can be conveniently selected for massage use.

The adjustable structure may be modified according to usage requirements to regulate the radial tightness, thereby changing the radial tightness of the massage body and achieving different wrapping effects on the penis placed inside.

In the massagers in the relevant art, the massage body is often placed inside the handheld device, making it irreplaceable or inconvenient to replace, with unchangeable wrapping intensity. During massage, the massage body is squeezed, causing it to expand outward. The bracket may constrain the massage body, and restrict its expansion. However, overly tight wrapping would lead to an excessive massage intensity, causing discomfort or affecting the massage effect. In this embodiment, an adjustable bracket structure is used. The massage bracket adopts a split structure, the upper cover of the bracket is movably connected to the base, they are connected by the adjusting knobs, and used as the fastener. By the tightness adjustment of the adjusting knobs, the distance between the upper cover and the base can be conveniently adjusted, and the tightness of the massage body can be adjusted. When a looser enveloping massage effect is needed, the connection can be loosened; when a stronger enveloping massage effect is required, the connection can be tightened. The bracket may be flexibly adjusted as needed, so that the adaptability is stronger and the use experience is better.

Further, connection parts 2-11 are provided on two sides of the bracket upper cover 2-1 and extend downwardly for connecting to the bracket base 2-2. A groove 2-12 is formed in each of the connection parts 2-11 for mating with a corresponding one of the adjusting knobs 2-4. When the adjusting knobs 2-4 are loosened, the adjusting knobs 2-4 move within the groove 2-12, so as to adjust the relative distance between the bracket upper cover 2-1 and bracket base 2-2 in the radial direction. Fixing plates 2-22 with slot structures are respectively provided on two sides of the bracket base 2-2 for constraining the connection parts 2-11. The center of the fixing plate 2-22 is provided with a fixing screw hole mating with the adjusting knob 2-4, facilitating the rotation of the adjusting knobs 2-4 to adjust the tightness. A slip prevention pad 2-3 is arranged in the bracket base 2-2 for preventing the slipping of the massage body. In this embodiment, the connection between the upper cover and the base of the bracket is achieved by inserting the connection parts into the slot structures on the inner sides of the fixing plates. Then, the adjusting knob is passed through the fixing screw hole and tightened to secure the connection. When the adjusting knob is loosened, the pressure from the fixing plate on the connection part is reduced, allowing the connection part to move and enabling the adjusting knob to move within the groove. The groove is used for the adjustment and fixing of the adjusting knob. This facilitates the adjustment of the upper cover of the bracket, thereby regulating the constraining effect on the massage body and achieving easy adjustment of tightness.

Further, a bottom of the bracket base 2-2 is provided with at least one hollow connecting column 2-21 for connecting to the handpiece 1. The hollow connecting column 2-21 is provided with internal threads for connection. In this embodiment, four connecting columns are arranged on the bracket base as a connecting and fixing structure with the handpiece. Specifically, two of the four connecting columns are a group, taking the sequential position as an example, the first and third connecting columns are the first group, and the second and the fourth connecting columns are the second group. The interval between the first and third connecting columns is equal to that between the second and fourth connecting columns. By adopting the setting of the crossing positions, and connecting to the first and third connecting columns or the second and fourth connecting columns at the same time, the connection positions with the hand piece can be adjusted in a limited space, so that the position of the massage body is different from the initial position and the end position, and different use experiences can be obtained.

Further, the handpiece 1 is provided with an integrated handle 1-4 for facilitating gripping. The handpiece 1 is provided with function keys 7 for operating the massage function. A moving groove 1-21 is formed in the bottom of the handpiece 1 for movement of the massage bracket 2. In this embodiment, the handle is an integrated game handle. In this example, the structure of two handles is illustrated, so that users can have a game experience during massage and give a game experience during the massage health care. According to the needs of production and use, a single handle structure or no handle can be set.

The moving groove is a travel groove, in which the massage bracket moves, and the moving massage of the massage body is realized by the driving of the driving mechanism.

Function keys 7 are arranged on the hand piece, and a control motherboard 8 is arranged in the hand piece to be electrically connected to the function keys. A rechargeable battery 4 is also arranged in the hand piece to be electrically connected to the control motherboard 8, so that the device can be used at any place more conveniently after being charged. The control motherboard with an integrated control IC (Integrated Circuit) is arranged in the hand piece, in which various moving speed modes are set, and the moving speed can be manually controlled step by step. Multiple function keys are arranged on the hand piece, so that both hands can perform function control and control the massage process more accurately.

Further, a movable connecting member 6 is provided in the handpiece 1 for connecting to the massage bracket 2, and the driving motor 5 is connected to the movable connecting member 6 in the transmitting manner to drive the massage bracket 2 to move reciprocally on the handpiece 1 along the moving groove 1-21. In this embodiment, the transmission system uses a lead screw. The transmission screw is connected to the movable connecting member in a threaded manner. The motor can better cooperate with the transmission screw to precisely control the moving stroke of the massage bracket. Specifically, the driving motor drives the transmission screw through forward rotation and reverse rotation, and the transmission screw then drives the movable connecting member to move back and forth, so as to realize the reciprocating control of the massage bracket. Pulse width modulation (PWM) signal is used to control the driving voltage of DC (Direct Current) motor, in which the duty ratio of PWM signal determines the average voltage applied to two ends of the motor, so as to realize accurate control of the motor speed. The higher the duty ratio, the higher the average voltage obtained by the motor and the faster the rotation speed, whereas the lower the duty ratio, the slower the rotation speed. By adjusting the duty ratio of PWM signal, the speed of DC motor can be continuously adjusted without changing the power supply voltage of the motor. During use, it can be automatically massaged through a preset mode. The driving voltage of the DC motor is controlled by adopting pulse-width-modulation (PWM) signals. The duty cycle of the PWM signal determines the average voltage applied across the motor. A higher duty cycle means a higher average voltage and faster motor speed. Conversely, reducing the duty cycle lowers the speed. By adjusting the duty cycle of the PWM signal, the speed of the DC motor can be continuously and adjustably controlled without changing the motor's supply voltage. In the use process, automatic massage can be carried out through the preset mode to obtain massage effects suitable for different users.

In the embodiment, two sides of the driving screw are provided with guiding rods in sliding connection with the movable connecting member, which can ensure the stability of the massage bracket during moving, thus ensuring the massage effect in the actual massage use process.

### Embodiment 2

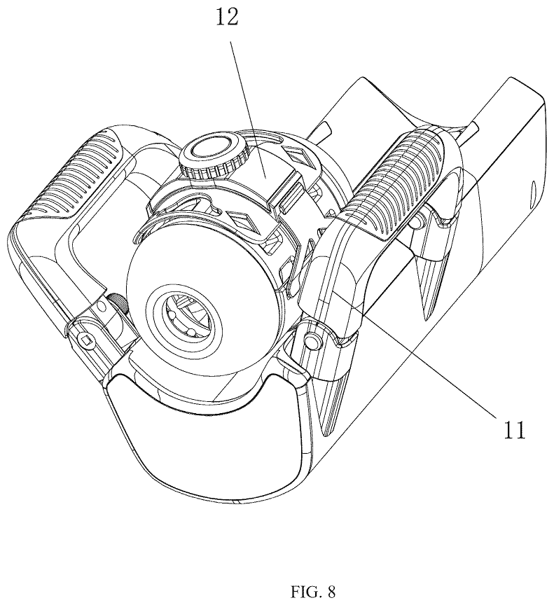

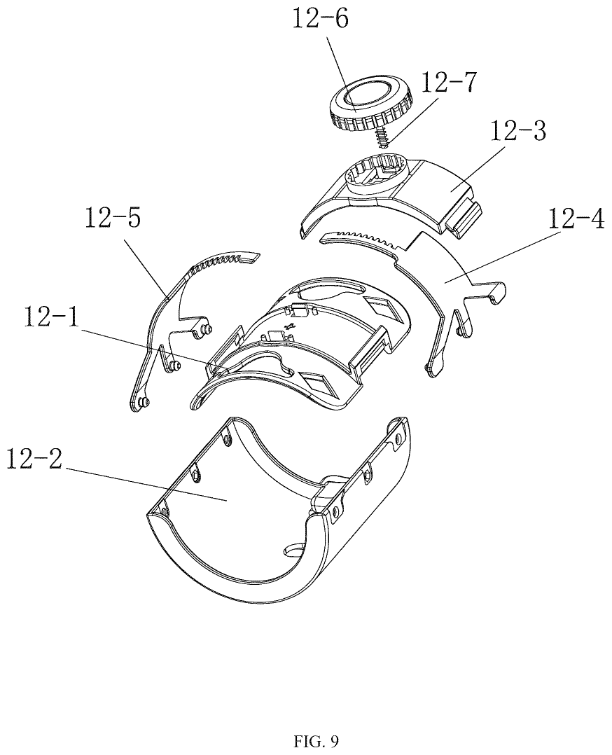

As shown in FIGS. 8-9, this embodiment differs from Embodiment 1 in that the handpiece 1 is provided with at least one foldable handle 11 for easy storage and adjusting the gripping angle. A rack-type massage bracket 12 is arranged on the handpiece 1, and the rack-type massage bracket 12 is configured to perform radial expansion and contraction from the top. The rack-type massage bracket 12 includes an upper cover plate 12-1 and a base plate 12-2 as carriers. The two sides of the base plate 12-2 as the bottom carrier are respectively provided with a first adjusting piece 12-4 and a second adjusting piece 12-5 for tension adjustment. The first and second adjusting piece have opposite radial rack structures. Above the rack sections of these two adjusting plates lies an adjusting seat 12-3 that limits the adjusting travel. An adjusting wheel 12-6 is provided on the adjusting seat 12-3. A bottom of the adjusting wheel 12-6 is provided with an adjusting rod 12-7 with teeth, and the adjusting rod extends into the space between opposite racks and engages with the racks, so as to drive the first adjusting piece 12-4 and the second adjusting piece 12-5 to move towards each other through a rotation of the adjusting wheel 12-6 and adjust the tightness. In this embodiment, by arranging two adjusting pieces with opposite racks and driving the adjusting pieces to move through the rotation of the adjusting wheel, not only the tightness can be adjusted conveniently, but also the stretching adjusting operation feel can be obtained in the adjustment process, which brings different use experiences and meets different use requirements.

### Embodiment 3

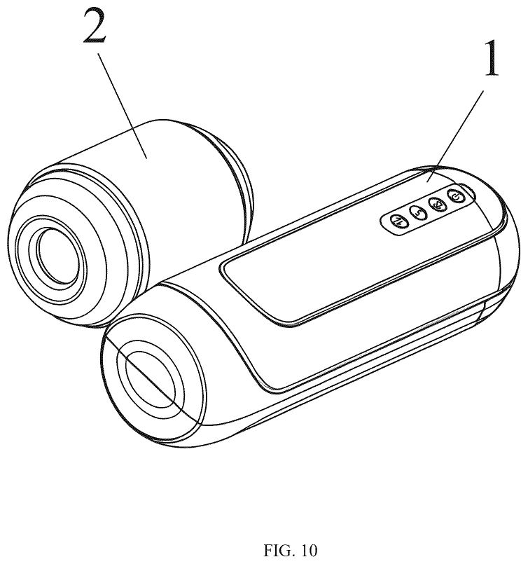

As shown in FIG. 10, this embodiment differs from Embodiment 1 in that the massage bracket 2 is an integrated structure connected to the handpiece 1 in the transmission manner. In this embodiment, the massage bracket is designed as a non-adjustable integrated structure, which is a choice made based on production costs. The non-adjustable structure can also facilitate the disassembly, replacement and cleaning of the massage body, but the radial tightness of the massage body cannot be adjusted according to the use requirements. Users may also choose the adjustable or non-adjustable structure according to the purchase cost when selecting, thus meeting the use requirements of more different users.

By the above technical solutions, the beneficial effects of the present disclosure are as follows. By placing the massage body in the adjustable bracket whose tension can be adjusted to strengthen or weaken the constraint on the massage body, the self-adaptive adjustment of the massage tightness during use is achieved. Different massage bodies can also be replaced as needed to meet various preferences. Additionally, the adjustable bracket is arranged on the handle shell, so that the movement of the massager can be conveniently controlled, and different massage health care effects can be obtained.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope of the present disclosure.

What is claimed is:

1. A massager with an external massage assembly, comprising: a handpiece and a massage bracket arranged externally to the handpiece, wherein a massage body is provided in the massage bracket for massaging a penis.

2. The massager according to claim 1, wherein a driving motor is provided in the handpiece, and the driving motor is connected to the massage bracket in a transmitting manner.

3. The massager according to claim 1, wherein the massage bracket comprises a bracket upper cover and a bracket base for constraining the massage body in a radial direction.

4. The massager according to claim 3, wherein adjusting knobs are provided between the bracket upper cover and bracket base for adjusting tightness in the radial direction, and the adjusting knobs are configured to adjust a relative distance between the bracket upper cover and bracket base by rotation, so as to adjust the tightness of the massage body in the radial direction.

5. The massager according to claim 4, wherein connection parts are respectively provided on two sides of the bracket upper cover and extend downwardly for connecting to the bracket base.

6. The massager according to claim 5, wherein a groove is formed in each of the connection parts for mating with a corresponding one of the adjusting knobs; and when the corresponding one of the adjusting knobs is loosened, the corresponding one of the adjusting knobs is configured to move within the groove, so as to adjust the relative distance between the bracket upper cover and bracket base in the radial direction.

7. The massager according to claim 5, wherein fixing plates with slot structures are respectively provided on two sides of the bracket base for constraining the connection parts.

8. The massager according to claim 3, wherein a bottom of the bracket base is provided with at least one hollow connecting column for connecting to the handpiece.

9. The massager according to claim 1, wherein the handpiece is provided with an integrated handle for facilitating gripping.

10. The massager according to claim 1, wherein a movable connecting member is provided in the handpiece, the movable connecting member is connected to the massage bracket, and the driving motor is connected to the movable connecting member in the transmitting manner so as to drive the massage bracket to move reciprocally on the handpiece.

11. The massager according to claim 1, wherein the massage body is provided with a hollow massage portion for accommodating the penis.

12. The massager according to claim 1, wherein the massage bracket is a rack-type massage bracket provided on the handpiece, and the rack-type massage bracket is configured to perform radial expansion and contraction from the top.

13. The massager according to claim 12, wherein the rack-type massage bracket comprises an upper cover plate and a base plate as carriers, and two sides of the base plate as a bottom carrier are respectively provided with a first adjusting piece and a second adjusting piece for adjusting tightness.

14. The massager according to claim 13, wherein the first adjusting piece and the second adjusting piece are provided with radial rack structures facing each other, and an adjusting seat is provided above rack sections of the first adjusting piece and the second adjusting piece for constraining an adjusting travel.

15. The massager according to claim 14, wherein the adjusting seat is provided with an adjusting wheel, a bottom of the adjusting wheel is provided with an adjusting rod with teeth, and the adjusting rod extends into a space between opposite racks and engages with the racks, so as to drive the first adjusting piece and the second adjusting piece to move towards each other through a rotation of the adjusting wheel and adjust the tightness.

16. The massager according to claim 1, wherein the massage bracket is an integrated structure.
